(19) United States
(12) Patent Application Publication
(10) Pub. No.: US 2004/0052081 A1
(43) Pub. Date: Mar. 18, 2004

(54) Light source steadying assembly

(76) Inventors: Chun-I Hsiao, Hsin-Chu City (TW); Chen-Ho Lee, Hsin-Chu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/245,693

(22) Filed: Sep. 18, 2002

(51) Int. Cl. F21V 15/04

(52) U.S. Cl. 362/390; 362/330; 362/29

(57) ABSTRACT

A light source steadying assembly which fixes the relative distance between the lighting device and the transparent device by the elastic structure, such that all deformations induced by assembly and operation are absorbed. The elastic structure could be located in the gap between the chassis and the lighting device or in the gap between the lighting device and the transparent device. Further, the connecting structure is optional to be located in the gap without the elastic structure such that the angle between the transparent device and the lighting device is further fixed.

### BACKGROUND OF THE INVENTION

1. Field of the Invention

This present invention relates to a light source steadying assembly, and more particularly, to a light source steadying assembly which fixes the relative distance between the lighting device and the transparent device by the elastic structure.

2. Description of the Prior Art

Those conventional arts will recognize that, for example, in a scanner, when a lighting device is mounted between a chassis and a transparent device for the light of the lighting device through the transparent device illuminating a object or further the lighting device moving relative to the transparent device. As is apparent form FIGS. 1A-1B, the lighting device 11 is normally mounted on the chassis 12 (fixes the relative distance between the lighting device 11 and the transparent device 12), and kept the lighting device 11 and the chassis 12 each other to separate from the transparent device 13. Therefore, on the one hand the lighting device is mounted on the edge of the transparent device 13 for illuminating efficiently a object 14 through the transparent device 13, on the other hand the lighting device 11 moves relative to the transparent device 13 by moving the chassis 12.

Due to the processes of assembly hard to avoid the inaccuracy, for example, each device is not fabricated indeed as design or not fixed indeed; hard to avoid the collision when transporting; deformation and loose due to operation repeatedly. Those conventional arts will recognize two faults as listed below that:

As shown in FIG. 1C, the trajectory of the chassis 12 and the transparent device 13 aren't parallel obviously. Therefore the brightness the lighting device 11 projecting to the object 14 is different on the different portion of the object 14 (assumed the lighting device 11 is stable), and so the operation of scanner etc causes departure due to the various distribute of brightness.

As shown in FIG. 1D, the lighting device 11 and the transparent device 13 is not parallel obviously in the direction perpendicular the trajectory of the chassis 12. And so, no matter the chassis 12 move or not, the brightness of the different portion of the object 14 illuminated from a lighting device 11 is different (assumed the lighting device is stable), and so the movement of scanner etc. cause departure due to the various distribute of brightness.

Moreover, two faults as shown in FIG. 1C and 1D are not existing, as shown in FIG. 1E, due to a gap between the lighting device 11 and the transparent device 13, the light 15 emitted by the lighting device 11 disperses around, and so the using efficiency of the lighting device 11 decreases. Of course, as shown in FIG. 1F, those conventional arts will recognize that the converging light assembly 16 is mounted on one side of the lighting device 11 facing the transparent device 13 for converging the light 15 to the transparent device 13. Therefore, the using efficiency of the lighting device 11 can increase, but the extra cost also increase and the whole structure complicates.

In accordance with the above-mentioned objects, those conventional arts will recognize that the lighting device is fixed and the efficiency of the lighting device increase simultaneously, it is hard to archive. Hence, it is need to further improve.

### SUMMARY OF THE INVENTION

It is another object of this invention to improve the method for fixing the lighting device to avoid the faults of those conventional arts.

It is still another object of this invention to provide a light source steadying assembly to fix the lighting device and increase the efficiency of the lighting device simultaneously on the premise that the relationship between the chassis, the lighting device, and the transparent device doesn't change mainly.

In this present invention, it provides that a light source steadying assembly is mounted in the gap between the lighting device and the chassis by a elastic structure for mounting the lighting device on the transparent device without space the transparent device. And, the elastic structure is generally in a compressed state for absorbing the deformation and displacement. Furthermore, a connecting structure is optional to be located in the gap between the lighting device and the transparent device for fixing the angle between the lighting device and the transparent device.

In this present invention, another light source steadying assembly employs the elastic structure to connect the lighting device and the transparent device for fixing the relative position between the transparent device, the lighting device, and the chassis. And, the elastic structure is generally in a compressed state for absorbing the deformation and displacement. Furthermore, the connecting structure is optional to be located in the gap between the lighting device and the transparent device for fixing the angle between the lighting device and the transparent device.

### BRIEF DESCRIPTION OF THE DRAWINGS

FIG. 1A to FIG. 1F is a diagram showing the structure and the common faults of the light source steadying assembly in the conventional arts;

FIG. 2A to FIG. 2J is a diagram showing some possible structure of a preferred embodiment in this present invention; and

FIG. 3A to FIG. 3E is a diagram showing some possible structure of another preferred embodiment in this present invention

### DESCRIPTION OF THE PREFERRED EMBODIMENT

In according with those common faults of those conventional arts, the inventor of this present invention first point out the key of that cause the faults:

First: the lighting device contacts indirectly with the transparent device, and so avoids wastage due to friction, but hard to avoid the efficiency of the lighting device reducing or needing an extra converging lighting device.

Second: due to the lighting device is mounted directly on the chassis, any space can't be a buffer to absorb the deformation and displacement as a result of the collision, the wastage, or the fault of assembly.

Furthermore, the inventor of this present invention provides several ideas for solving efficiently the faults of those conventional arts:

First: the lighting device is connected with the transparent device without space for avoiding those faults such as to reduce the efficiency of lighting device or to need an extra converging lighting device etc.

Second: due to the lighting device being connected with the transparent device without space, the problem that is the friction therebetween causes. Therefore, a little gate is therebetween or a connecting structure is employed to connect the lighting device and the transparent device.

Third: a little gate employed still causes those faults as well as those conventional arts except the fault of level being reduced. Therefore, the connecting structure employed is a better choice. Hence, a low friction of material is employed as the connecting structure for reducing the friction; the connecting area of the connecting structure and the transparent device is on the edge of connecting structure and the transparent device (or isn't on the center between a processed material and the lighting portion of lighting device) for reducing the influence.

Forth: a elastic structure is employed for absorbing the deformation and displacement induced by the collision, the wastage, and the fault of assembly. Due to the specifications and the functions of the cassis, the lighting device, and the transparent device are definite, the best method is that the elastic structure is installed invariably on the lighting device, such as a spring, a leaf spring etc.

Fifth: only if the application of the elastic structure archives the absorbing function between the cassis, the lighting device, and the transparent device. And, it is unlimited the elastic structure particularly or unlimited the elastic structure to be installed between the chassis and the lighting device or between the lighting device and the transparent device.

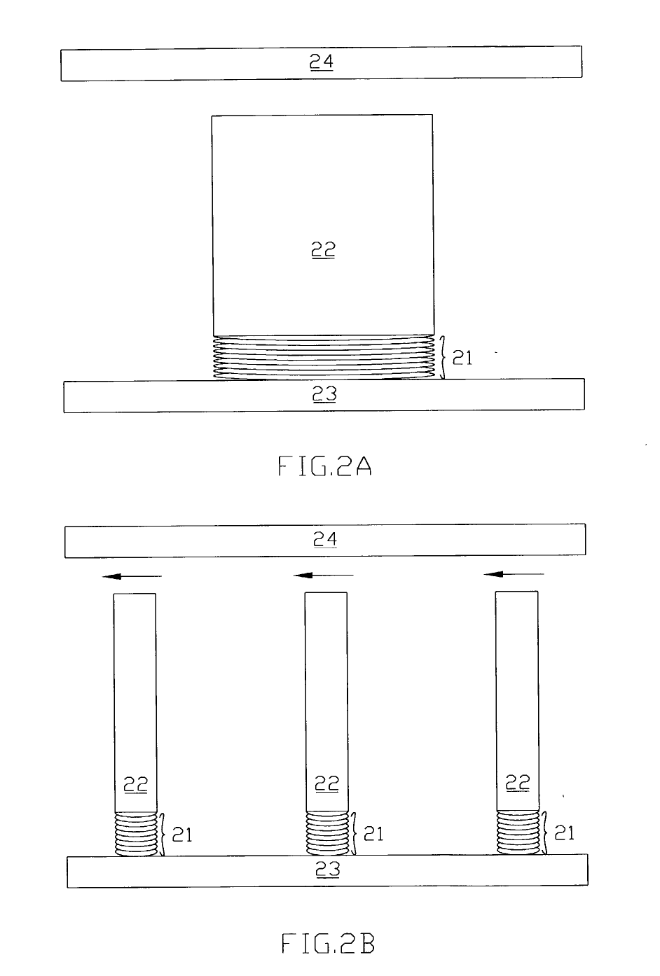

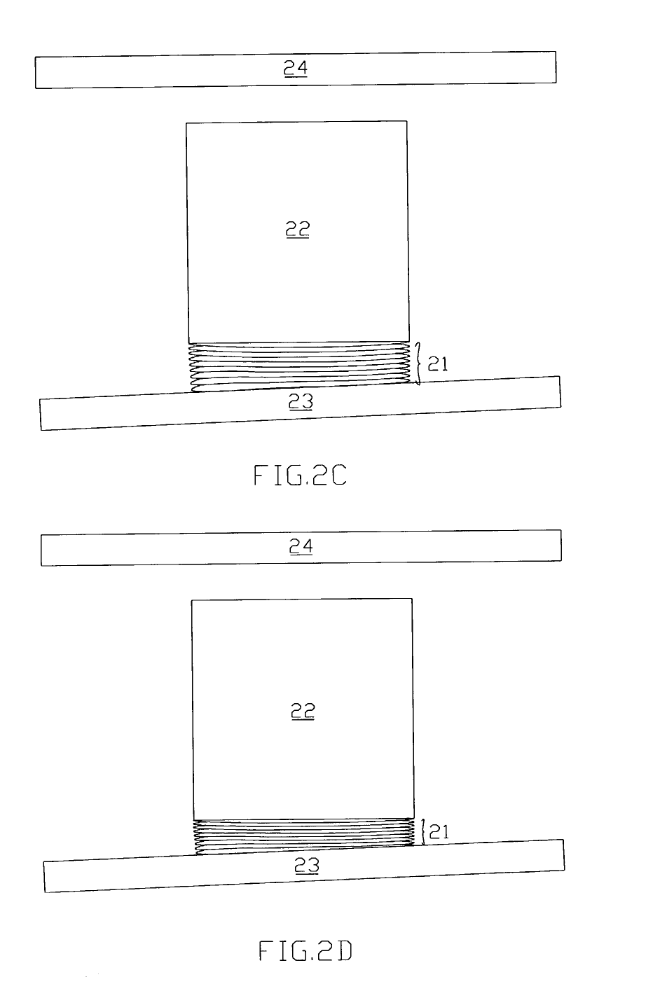

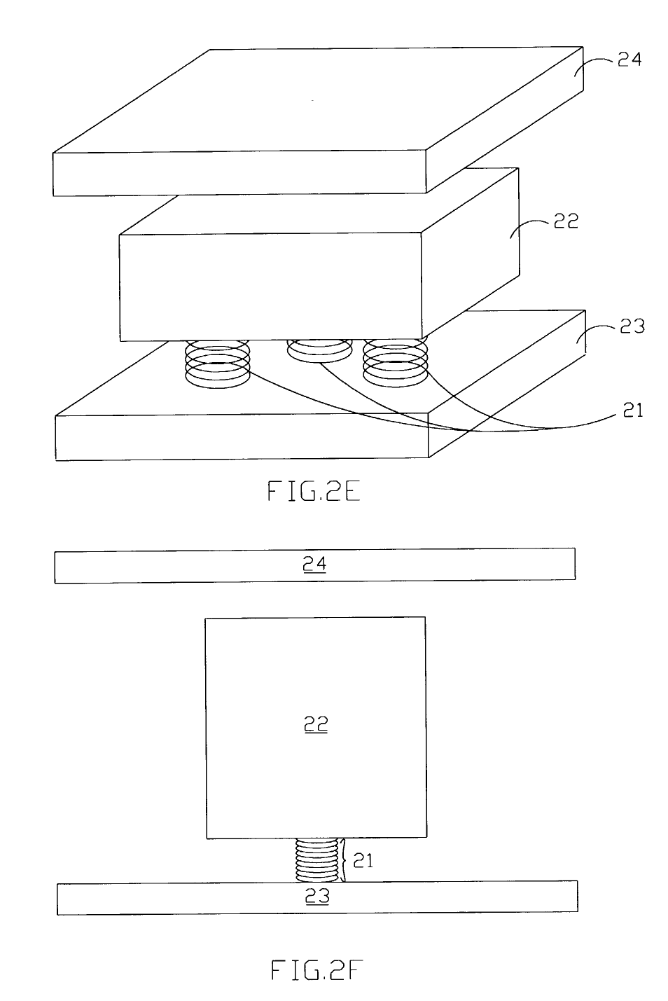

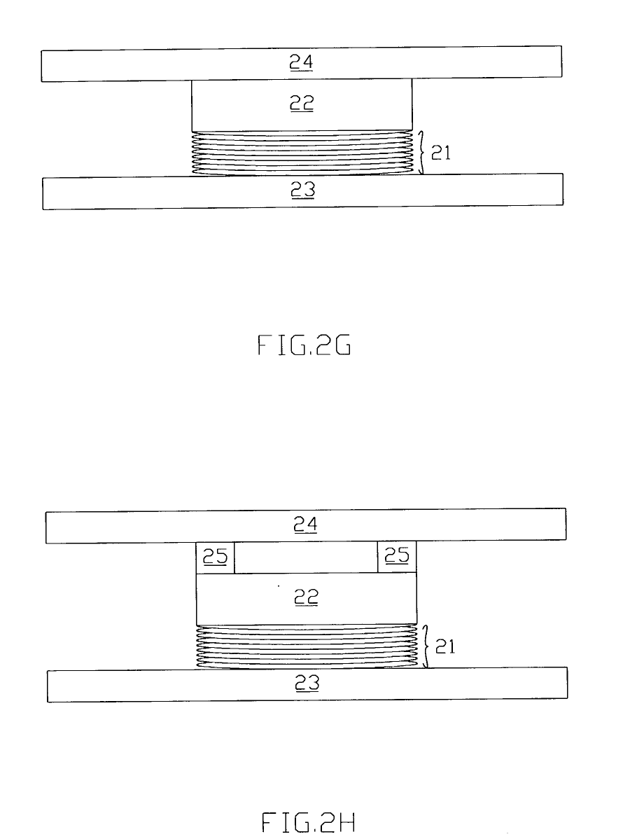

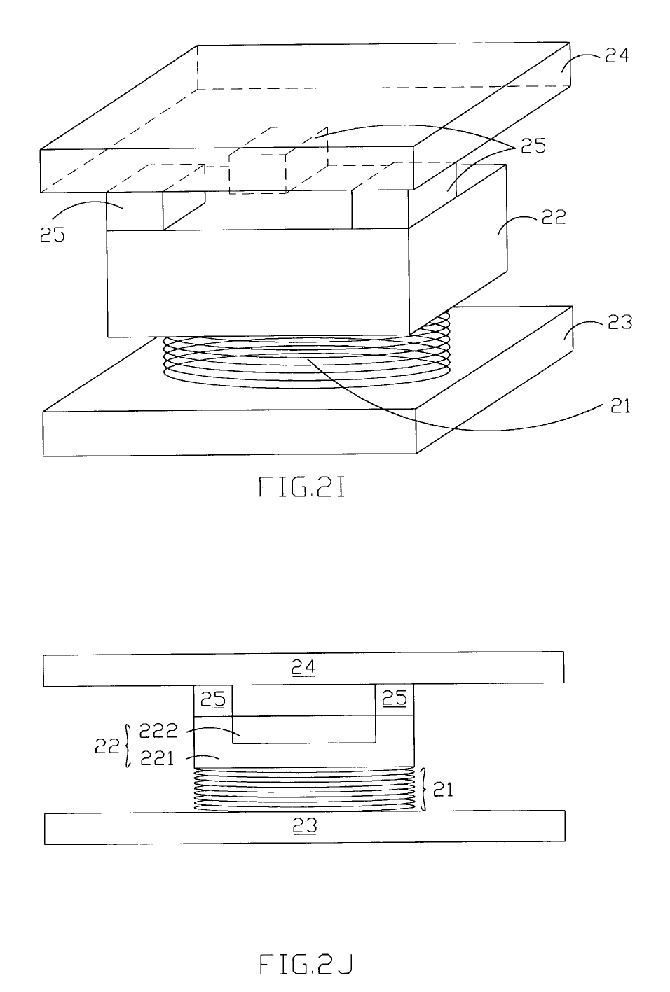

According to the above-mentioned, a preferred embodiment of this present invention is a light source steadying assembly. As shown in FIG. 2A, the basic composition of the embodiment comprises an elastic structure 21. The elastic structure 21 connects a lighting device 22 and a chassis 23, and the lighting device 22 is between the chassis 23 and a transparent device 24. Wherein, the composing unit can be a spring, a leaf spring, a sheetmetal, a leaf plastic, a ribbing structure, a curved structure, a leaf rubber, or one selected from the group consisting of the above-mentioned units. The material of the transparent device 24 can be a glass, a polysulfone, a plastic, or one selected from the group consisting of the above-mentioned units.

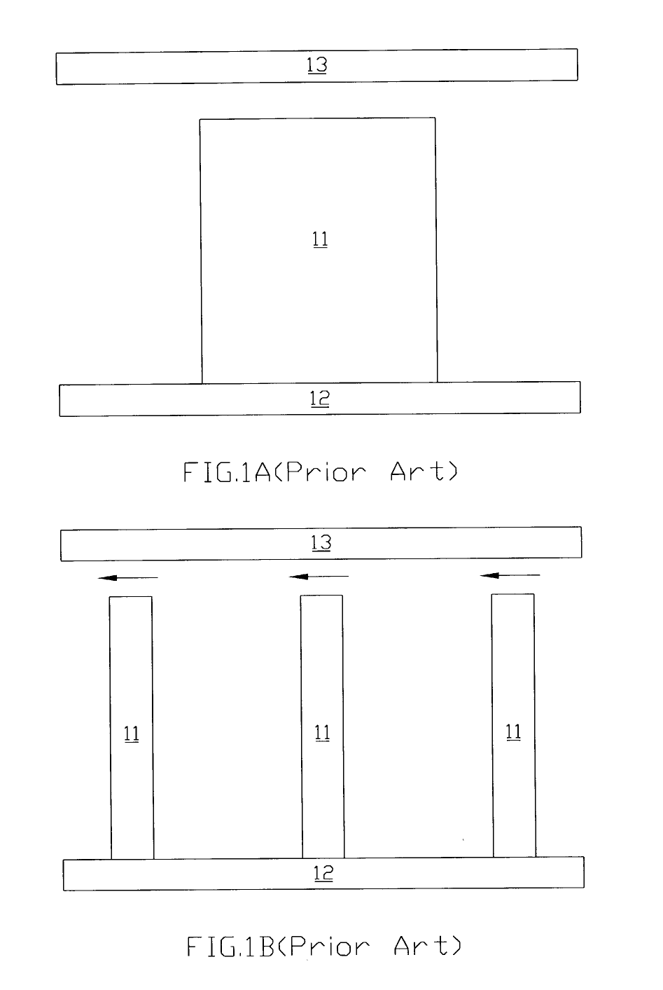

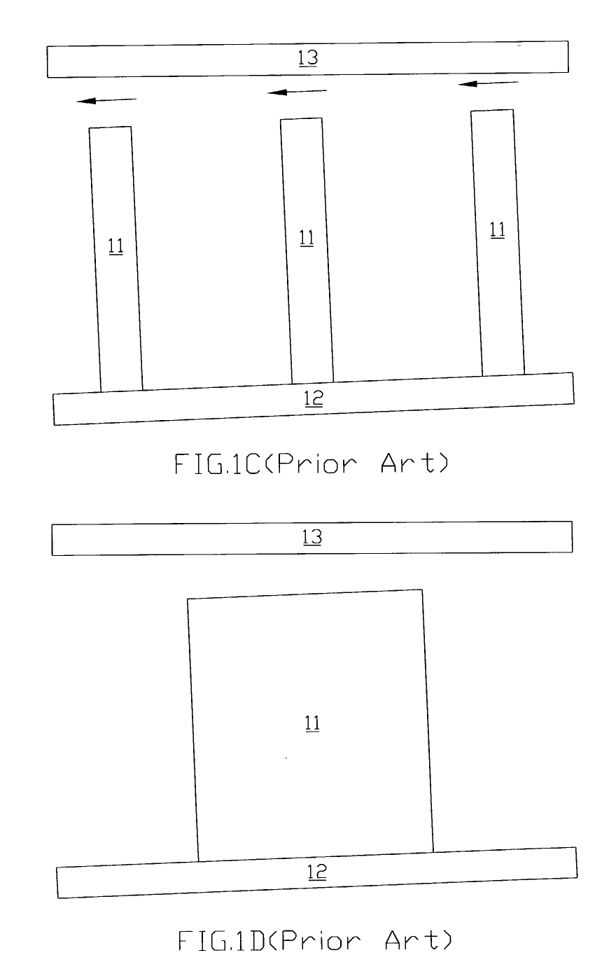

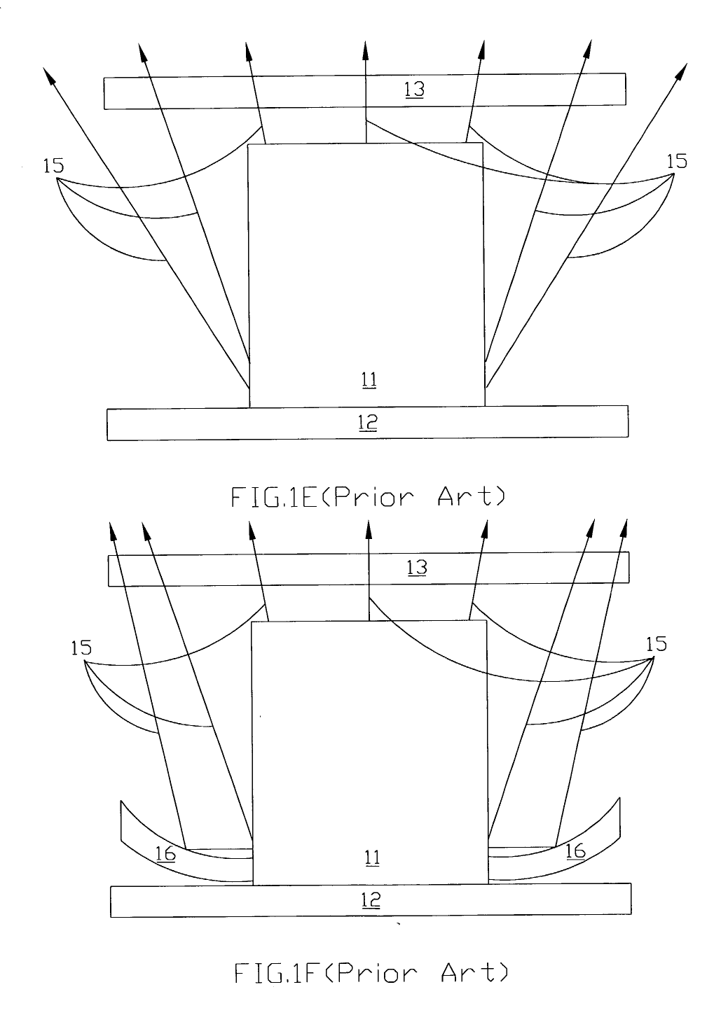

Obviously, the elastic structure 21 between the lighting device 22 and the chassis 23 can absorb the deformation and the wastage between the lighting device 22, the chassis 23, and the transparent device 24, as shown in FIG. 2B and FIG. 2C, to improve efficiently the faults of those conventional arts as shown in FIG. 1C and FIG. 1D.

Furthermore, for archiving efficiently the absorbing function, as shown in FIG. 2D and FIG. 2F, the elastic structure 21 has some variations as listed below: the elastic structure 21 is to be in a compressed state for offsetting the downward gravitational displacement of those common configuration on the lighting device 22 (even the transparent device 24) upon the chassis 23. The elastic structure 21 can comprise at least three elastic structures that aren't colinear each other for providing a support below the lighting source and reducing the possibility of slant due to the lighting device taking unbalanced force. The elastic structure 21 also can be between the center of gravity of the lighting device 22 and the chassis 23 for ensuring the relative displacement etc being absorbed by the elastic structure 21.

Besides, for avoiding the faults induced by the gap between the lighting device 22 and the transparent device 24, the light source steadying assembly provided by this present embodiment allows the lighting device 22 to connect directly with the transparent device 23 (without space). It also can allow employing the connecting structure 25 to connect the lighting device 22 and the transparent device 24 (still with a gate, but contact directly by the connecting structure).

Obviously, the variation as shown in FIG. 2G, the possibility of archiving the maximal efficiency of the variation is higher than the variation as shown in FIG. 2H, but the possibility of the fault of the fricative wastage is higher. Hence, when applying this present invention, the variation depend on actual demand is selected the maximal total efficiency. It is necessary to say that the variation as shown in FIG. 2H, improves the fault by narrowing the distance between the lighting device 22 and the transparent 24 and changing the structure and the material of the connecting structure 25.

Although the connecting structure is on two opposite extremities of the lighting device 22, as shown in FIG. 2H, due to the main function of the connecting structure 25 is not absorbing displacement etc, one end of he connecting structure 25 connects with the transparent device 24 and other end connects with the sidewall of the lighting device 22.

In addition, for further controlling the angle between the transparent device 24 and the lighting device 23, avoiding the variation of the angle between the transparent device 24 and the lighting device 23 to causing the brightness of the lighting source through the transparent device 24 projecting on a object unstable/disproportionate, as shown in FIG. 21, the connecting structure 25 comprises at least three connecting structures that aren't collinear each other. For avoiding the connecting structure 25 to affect the brightness of the lighting source 21 through the transparent device 24 projecting on a object, as shown in FIG. 2J, the connecting structure 25 is just installed between the portion of not lighting 221 of the lighting device and the transparent device 24 and not between the portion of lighting 222 of the light device and the transparent device 24. Furthermore, for reducing the fricative wastage between the connecting structure 25 and the transparent device 24, the material of the connecting structure 25 can be a plastic, a rubber, a material with low fricative coefficient, a material with low hardness or one selected from the group consisting of above-mentioned material.

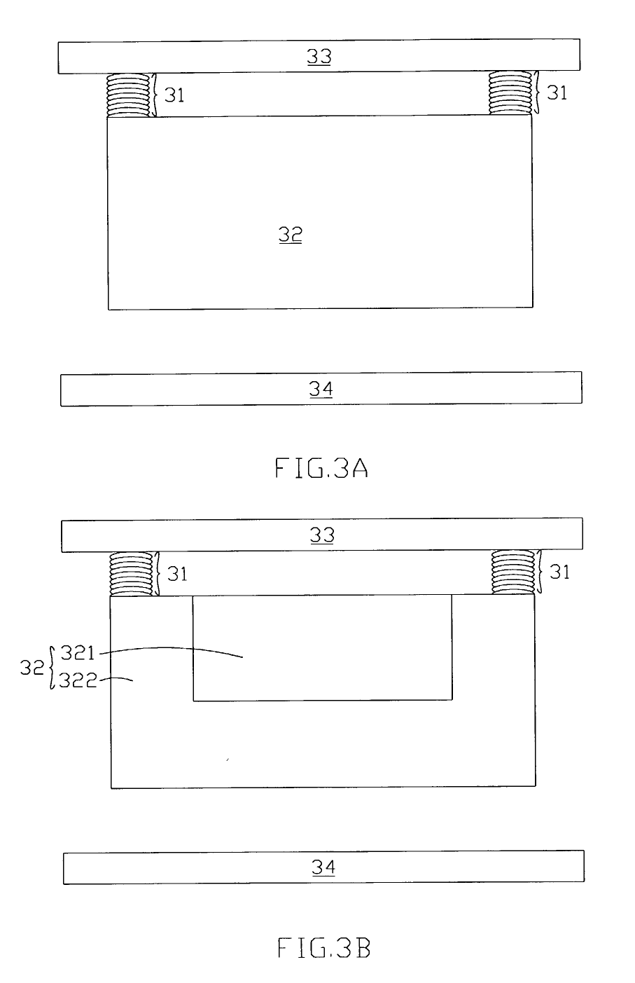

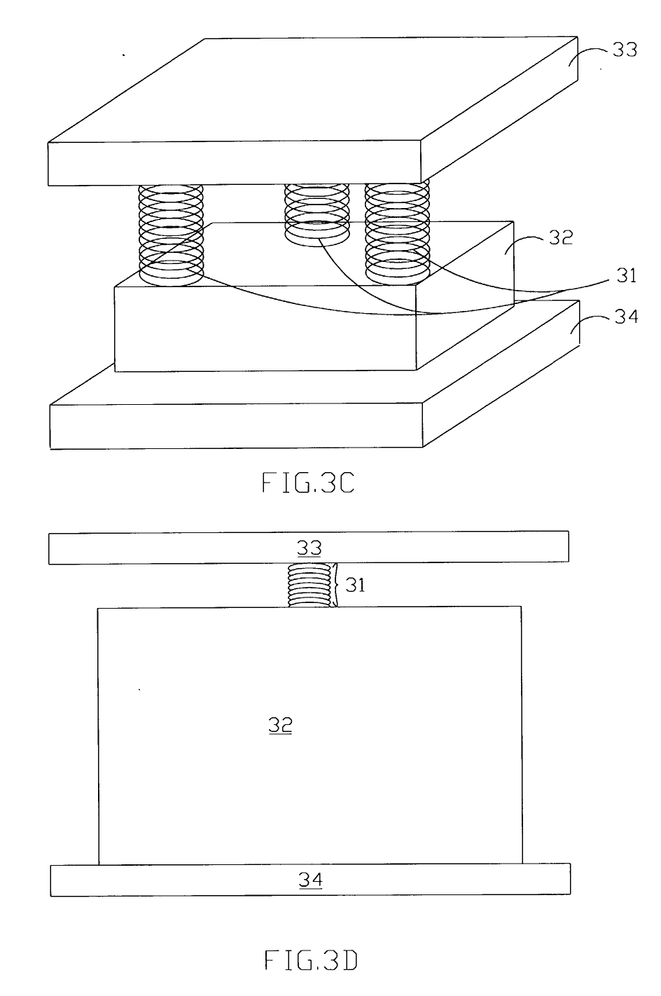

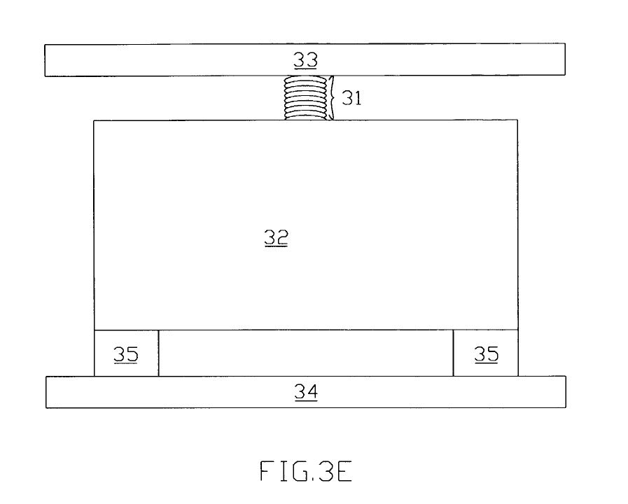

Another preferred embodiment according to this present invention is still a light source steadying assembly, as shown in FIG. 3A, comprising at least the elastic structure 31. The elastic structure 31 connects the lighting device 32 and the transparent device 33, and the lighting device 32 is between the transparent device 33 and the chassis 34.

Obviously, the main difference of this embodiment and the above-mentioned embodiment is the different position of the elastic structure 31. The above-mentioned embodiment is that absorbs the deformation between the lighting device 22 and the chassis 23. Hence, the detail of this embodiment is the same with the above-mentioned embodiment except relative directly to the position of an elastic module (21&31).

In other words, the composing unit of the elastic module can be:

a spring, a leaf spring, a sheetmetal, a leaf plastic, a ribbing structure, a curved structure, a leaf rubber, or one selected from the group consisting of the above-mentioned. And, the matrial of the transparent device can be: a glass, a polysulfone, a plastic, or one selected from the group consisting of the above-mentioned units. Furthermore, the elastic structure 31 can be in a compressed state.

For avoiding the elastic structure 31 affecting the normal motion of the lighting device, as shown in FIG. 3B, the elastic structure 31 is between a not lighting portion 322 and the transparent device 33, wherein the lighting portion 321 and the not lighting portion 322 separate from the opposite surfaces of the lighting device 32 and the transparent device 33. As shown in FIG. 3C, the elastic structure comprises at least three elastic structures that aren't collinear each other.

The lighting device 32 can contact directly with the chassis 34, as shown in FIG. 3D, or a connecting structure can be employed to connect the lighting device 32 and the chassis 34, as shown in FIG. 3E. And, the connecting structure 35 is between the center-of-gravity position of the lighting device 32 and the chassis 34, also can comprise at least three connecting structures that aren't collinear each other. Furthermore, the material of the connecting structure 35 can be a plastic, a rubber, a material with low fricative coefficient, a material with low hardness or one selected from the group consisting of above-mentioned material.

Although specific embodiments have been illustrated and described, it will be obvious to those conventional arts that various modifications may be made without departing from what is intended to be limited solely by the appended claims.

What is claimed is:

1. A light source steadying assembly, comprising:
an elastic structure connecting a lighting device and a chassis and said lighting device being between said chassis and a transparent device.

2. The light source steadying assembly according to claim 1, wherein said elastic structure is selected from the group consisting of a spring, a leaf spring, a sheetmetal, a leaf plastic, a ribbing structure, a curved structure, a leaf rubber.

3. The light source steadying assembly according to claim 1, wherein said elastic structure is in a compressed state.

4. The light source steadying assembly according to claim 1, wherein said elastic structure comprises at least three elastic structures that aren't colinear each other.

5. The light source steadying assembly according to claim 1, wherein said elastic structure is between the center-of-gravity position of said lighting device and said chassis.

6. The light source steadying assembly according to claim 1, wherein said elastic structure connects with said transparent device directly.

7. The light source steadying assembly according to claim 1, further comprises a connecting structure, wherein said connecting structure connects said lighting device and said transparent device.

8. The light source steadying assembly according to claim 7, wherein said connecting structure and said elastic structure is on two opposite extremities of said light source steadying assembly.

9. The light source steadying assembly according to claim 8, wherein said connecting structure comprises at least three elastic structures that aren't colinear each other.

10. The light source steadying assembly according to claim 7, wherein said connecting structure is selected from the group consisting of a plastic, a rubber, a material with low fricative coefficient, a material with low hardness.

11. A light source steadying assembly, comprising:
an elastic structure connecting a lighting device and a transparent device and said lighting device being between said transparent device and a chassis.

12. The light source steadying assembly according to claim 11, wherein said elastic structure is selected from the group consisting of a spring, a leaf spring, a sheetmetal, a leaf plastic, a ribbing structure, a curved structure, a leaf rubber.

13. The light source steadying assembly according to claim 11, wherein said elastic structure is in a compressed state.

14. The light source steadying assembly according to claim 11, wherein a lighting portion and a not lighting portion separate from the opposite surfaces of said lighting device and said transparent device and said elastic structure is between said lighting portion and said not lighting portion.

15. The light source steadying assembly according to claim 11, wherein said elastic structure comprises at least three elastic structures that aren't colinear each other.

16. The light source steadying assembly according to claim 11, wherein said lighting device connects directly with said chassis.

17. The light source steadying assembly according to claim 11, further comprises a connecting structure, wherein said connecting structure connects said lighting device and said transparent device.

18. The light source steadying assembly according to claim 17, wherein said connecting structure is between the center-of-gravity position of said lighting device and said chassis.

19. The light source steadying assembly according to claim 17, wherein said connecting structure comprises at least three connecting structures that aren't colinear each other.

20. The light source steadying assembly according to claim 7, wherein said connecting structure is selected from the group consisting of a plastic, a rubber, a material with low fricative coefficient, a material with low hardness.
